(19) United States
(12) Patent Application Publication
(10) Pub. No.: US 2024/0202171 A1
(43) Pub. Date: Jun. 20, 2024

(54) DETERMINING DUPLICATE ENTITIES IN CONTENT PACKS

(71) Applicant: VMWare, Inc., Palo Alto, CA (US)

(72) Inventors: Chandrashekhar Jha, Bangalore (IN); Mervin Nirmal John M W, Bangalore (IN)

(21) Appl. No.: 18/107,038

(22) Filed: Feb. 8, 2023

(30) Foreign Application Priority Data
Dec. 20, 2022 (IN) 202241073821

(51) Int. Cl. G06F 16/215; G06F 9/455; G06F 16/22

(52) U.S. Cl. CPC G06F 16/215; G06F 9/45558; G06F 16/2246; G06F 2009/45591

(57) ABSTRACT

A request to load a content pack can be received. A first duplicity check between the content pack and a previously loaded content pack can be performed. A second duplicity check between the content pack and the previously loaded content pack can be performed responsive to a determination that the content pack passed the first duplicity check. The content pack can be loaded responsive to a determination that the content pack passed the second duplicity check.

### RELATED APPLICATIONS

Benefit is claimed under 35 U.S.C. 119(a)-(d) to Foreign Application Serial No. 202241073821 filed in India entitled “DETERMINING DUPLICATE ENTITIES IN CONTENT PACKS”, on Dec. 20, 2022, by VMware, Inc., which is herein incorporated in its entirety by reference for all purposes.

### BACKGROUND

A data center is a facility that houses servers, data storage devices, and/or other associated components such as backup power supplies, redundant data communications connections, environmental controls such as air conditioning and/or fire suppression, and/or various security systems. A data center may be maintained by an information technology (IT) service provider. An enterprise may purchase data storage and/or data processing services from the provider in order to run applications that handle the enterprises' core business and operational data. The applications may be proprietary and used exclusively by the enterprise or made available through a network for anyone to access and use.

Virtual computing instances (VCIs) have been introduced to lower data center capital investment in facilities and operational expenses and reduce energy consumption. A VCI is a software implementation of a computer that executes application software analogously to a physical computer. VCIs have the advantage of not being bound to physical resources, which allows VCIs to be moved around and scaled to meet changing demands of an enterprise without affecting the use of the enterprise's applications. In a software defined data center, storage resources may be allocated to VCIs in various ways, such as through network attached storage (NAS), a storage area network (SAN) such as fiber channel and/or Internet small computer system interface (iSCSI), a virtual SAN, and/or raw device mappings, among others.

### BRIEF DESCRIPTION OF THE DRAWINGS

FIG. 1 is a diagram of a host and a system for determining duplicate entities in content packs according to one or more embodiments of the present disclosure.

FIG. 2A is a diagram of tree structures associated with two content packs according to one or more embodiments of the present disclosure.

FIG. 2B is another diagram of tree structures associated with two content packs according to one or more embodiments of the present disclosure.

FIG. 3 is a diagram of a system for determining duplicate entities in content packs according to one or more embodiments of the present disclosure.

FIG. 4 is a diagram of a machine for determining duplicate entities in content packs according to one or more embodiments of the present disclosure.

### DETAILED DESCRIPTION

The term “virtual computing instance” (VCI) covers a range of computing functionality, such as virtual machines, virtual workloads, data compute nodes, clusters, and containers, among others. A virtual machine refers generally to an isolated user space instance, which can be executed within a virtualized environment. Other technologies aside from hardware virtualization can provide isolated user space instances, also referred to as data compute nodes, such as containers that run on top of a host operating system without a hypervisor or separate operating system and/or hypervisor kernel network interface modules, among others. Hypervisor kernel network interface modules are data compute nodes that include a network stack with a hypervisor kernel network interface and receive/transmit threads. The term “VCI” covers these examples and combinations of different types of data compute nodes, among others.

VCIs, in some embodiments, operate with their own guest operating systems on a host using resources of the host virtualized by virtualization software (e.g., a hypervisor, virtual machine monitor, etc.). The tenant (i.e., the owner of the VCI) can choose which applications to operate on top of the guest operating system. Some containers, on the other hand, are constructs that run on top of a host operating system without the need for a hypervisor or separate guest operating system. The host operating system can use name spaces to isolate the containers from each other and therefore can provide operating-system level segregation of the different groups of applications that operate within different containers. This segregation is akin to the VCI segregation that may be offered in hypervisor-virtualized environments that virtualize system hardware, and thus can be viewed as a form of virtualization that isolates different groups of applications that operate in different containers. Such containers may be more lightweight than VCIs. While the present disclosure refers to VCIs, the examples given could be any type of virtual object, including data compute node, including physical hosts, VCIs, non-VCI containers, virtual disks, and hypervisor kernel network interface modules. Embodiments of the present disclosure can include combinations of different types of data compute nodes.

Logs are time-series records of actions and activities generated by applications, networks, devices (including programmable and IoT devices), and operating systems. They are typically stored in a file or database or in a dedicated application called a log collector for real-time log analysis. Log analysis is a process that gives visibility into the performance and health of IT infrastructure and application stacks, through the review and interpretation of logs that are generated by network, operating systems, applications, servers, and other hardware and software components. Logs can contain errors, warnings, text, etc. The contents of logs may be defined by developers of applications within the system. Many log analytics solutions that allow log analysis have gained market attraction in recent years (e.g., Sumo logic, Logz.io, VMware's vRealize Log insight (VRLI) cloud, etc.). These log analytics solutions have features such as querying, alerting, indexing, storage, analytics, etc.

Logs come in the form of completely unstructured or, in some cases, semi-structured, data which makes them difficult to analyze through machine learning. Therefore, log analytics systems usually rely upon a count of logs for providing a basic set of features such as event count or event trends. These features are useful to some extent but lack valuable insight about log content. In order to provide the ability for users to manage data efficiently, content packs may be employed. Content packs can be immutable or read-only plug-ins to log analytics solutions that provide predefined knowledge about specific types of events, such as log messages. A content pack can provide knowledge about a specific set of events in a format that is easily understandable by administrators, engineers, monitoring teams, and/or executives. Content packs give information about the health status of a product or application. In addition, a content pack can allow a user to understand how a product or an application works. Content packs contain dashboards, extracted fields, saved queries, and alerts that are related to a specific product or set of logs. Content packs can be enabled, disabled, exported, imported, and/or removed.

In some cases, a content pack may share content with another content pack such that the two content packs exhibit “duplicity.” Stated differently, a content pack may be a “duplicate” of another content pack. The phenomenon of duplicates may present itself in several scenarios. For example, a user can transition from one log analytics solution to another log analytics solution (e.g., vVRLI to VRLI Cloud platform), a user can import a content pack, and a user can customize a content pack. Duplicate content packs are undesirable because they create ambiguity, increase storage demand, and make content pack management tedious. In addition, entities inside a content pack (e.g., queries, fields, aggregations, alerts, dashboards, dashboard filters, visualizations, and/or agent groups) are expensive to process and therefore creating duplicates of those entities also results in high processing time and processing cost.

However, determining that one content pack is a duplicate of another is difficult. In previous approaches, determining that one content pack is a duplicate of another content pack may typically be done through tedious effort. Determining duplicity is a non-trivial task because content packs vary across vendors, applications, products, and environments. Content packs also contain user-created content, which is difficult to identify by simple methods. Therefore, various log analytics solution providers give different options for users to handle duplicity in content packs.

Embodiments of the present disclosure can identify duplicates in content packs. Embodiments herein not only determine duplicity in whole-content pack granularity but also in sub-features of content packs, such as queries, fields, aggregations, alerts, dashboards, dashboard filters, visualizations, and agent groups, which helps in managing storage efficiently. Embodiments herein not only help customers through a better experience but help providers save costs by reducing duplicity in the system.

As used herein, the singular forms “a”, “an”, and “the” include singular and plural referents unless the content clearly dictates otherwise. Furthermore, the word “may” is used throughout this application in a permissive sense (i.e., having the potential to, being able to), not in a mandatory sense (i.e., must). The term “include,” and derivations thereof, mean “including, but not limited to.” The term “coupled” means directly or indirectly connected.

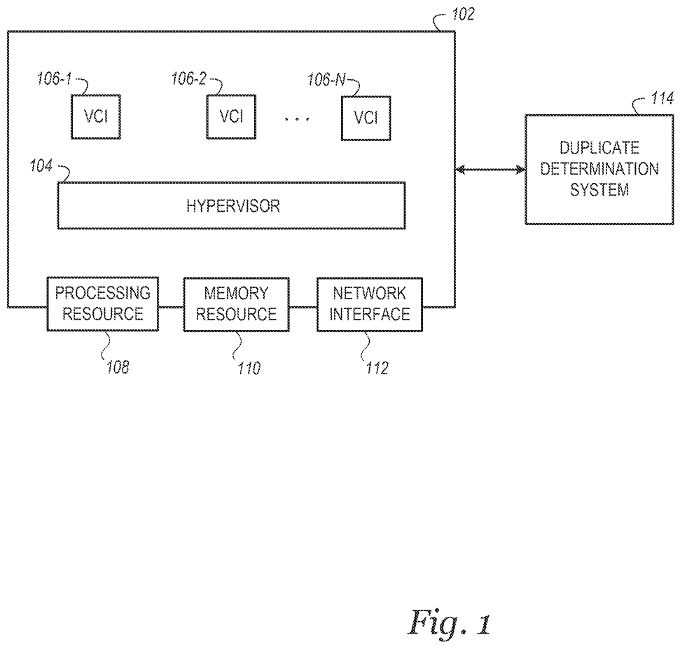

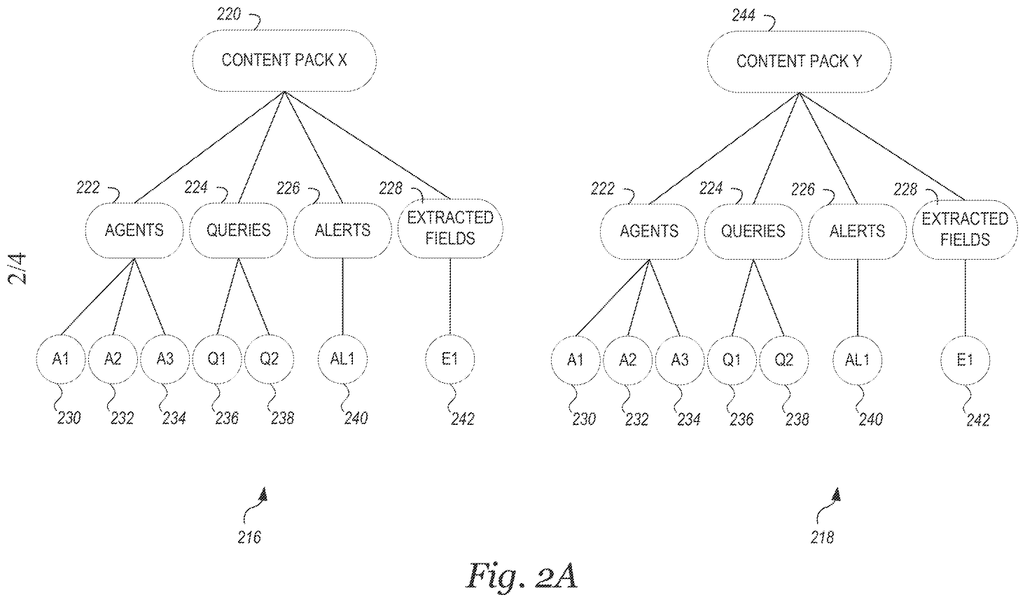

The figures herein follow a numbering convention in which the first digit or digits correspond to the drawing figure number and the remaining digits identify an element or component in the drawing. Similar elements or components between different figures may be identified by the use of similar digits. For example, 228 may reference element “28” in FIG. 2, and a similar element may be referenced as 928 in FIG. 9. Analogous elements within a Figure may be referenced with a hyphen and extra numeral or letter. Such analogous elements may be generally referenced without the hyphen and extra numeral or letter. For example, elements 116-1, 116-2, and 116-N in FIG. 1A may be collectively referenced as 116. As used herein, the designator “N”, particularly with respect to reference numerals in the drawings, indicates that a number of the particular feature so designated can be included. As will be appreciated, elements shown in the various embodiments herein can be added, exchanged, and/or eliminated so as to provide a number of additional embodiments of the present disclosure. In addition, as will be appreciated, the proportion and the relative scale of the elements provided in the figures are intended to illustrate certain embodiments of the present invention and should not be taken in a limiting sense.

FIG. 1 is a diagram of a host and a system for determining duplicate entities in content packs according to one or more embodiments of the present disclosure. The system can include a host 102 with processing resources 108 (e.g., a number of processors), memory resources 110, and/or a network interface 112. The host 102 can be included in a software defined data center. A software defined data center can extend virtualization concepts such as abstraction, pooling, and automation to data center resources and services to provide information technology as a service (ITaaS). In a software defined data center, infrastructure, such as networking, processing, and security, can be virtualized and delivered as a service. A software defined data center can include software defined networking and/or software defined storage. In some embodiments, components of a software defined data center can be provisioned, operated, and/or managed through an application programming interface (API).

The host 102 can incorporate a hypervisor 104 that can execute a number of virtual computing instances 106-1, 106-2, . . . , 106-N (referred to generally herein as “VCIs 106”) The VCIs can be provisioned with processing resources 108 and/or memory resources 110 and can communicate via the network interface 112. The processing resources 108 and the memory resources 110 provisioned to the VCIs can be local and/or remote to the host 102. For example, in a software defined data center, the VCIs 106 can be provisioned with resources that are generally available to the software defined data center and not tied to any particular hardware device. By way of example, the memory resources 110 can include volatile and/or non-volatile memory available to the VCIs 106. The VCIs 106 can be moved to different hosts (not specifically illustrated), such that a different hypervisor manages the VCIs 106. The host 102 can be in communication with a duplicate determination system 114. An example of the duplicate determination system 114 is illustrated and described in more detail below.

FIG. 2A is a diagram of tree structures associated with two content packs according to one or more embodiments of the present disclosure. When a new content pack is created, customized, or if a user is migrating from one log analytics solution to another (e.g., from VRLI to VRLI cloud), embodiments herein can perform a first check for basic duplicity between content packs (sometimes referred to herein as a “first duplicity check”). The duplicity may be between the new content pack and one or more existing content packs. This check can be performed using basic criteria. Such criteria can include the names of the respective content packs, the versions of the respective content packs, the authors of the respective content packs, and the namespaces of the respective content packs. In some embodiments, duplicates in any of those criteria cause the determination of duplicate content packs. In some embodiments, duplicates in all of those criteria cause the determination of duplicate content packs. In some embodiments, duplicates in a subset of those criteria cause the determination of duplicate content packs. In some embodiments, the determination of duplicity can cause the new content pack not to be loaded (e.g., to be discarded) and the existing content pack(s) to be retained.

If the basic duplicity check did not yield the determination of a duplicate, embodiments herein can perform a second duplicity check. As known to those of skill in the art, each content pack includes various modules (e.g., entities) as components. These modules include agent groups, alert definitions, dashboard definitions, extracted fields, query definitions, and agents.

Agent groups include defined groups of agents within a content pack. Alert definitions include a list of alerts and the details of those alerts in a content pack. Dashboard definitions include a list of dashboards in a content pack. Dashboard definitions can include widgets and queries associated with those widgets. Extracted fields can include a list of extracted fields in a content pack. Query definitions can include a list of queries in the content pack and their definitions. Agents can include a list of agents and/or agent configurations in a content pack.

These modules can be represented in a tree structure (e.g., a graph) including a plurality of nodes. Each node can include the above details with a classifier (e.g., a node Type classifier). The classifier can include the type of the node (e.g., ContentPack, AgentGroup, Alert, Dashboard, ExtractedField, etc.). Using the classifier, embodiments of the present disclosure can compare the nodes of the tree structure with nodes of other tree structures associated with existing content packs (e.g., nodes that are already stored) and identify duplicates. The process, in some embodiments, can be summarized by:
Step 1. Get the payload of Content Pack to be saved
Step 2. Verify if there is a Content Pack with the same name, version, author, namespace
Step 3. If Yes, show the user that already content pack exists
Step 4. If No, Convert the payload into a Tree Structure
Step 5. Mark Content Pack, Agents, Queries, Alerts, Extracted Field with relevant nodeType enums
   nodeType Enums can include below values
      a. ROOT
      b. AGENT
      c. QUERY
      d. ALERTS
      e. EXTRACTED FIELD
      f. CHILD
Step 6. Based on the nodeType, verify all the nodes of the tree except CHILD nodeType are same with that of DB entries.
Step 7. If Yes, then there is a Duplicate.
Step 8. If No, then there is no Duplicate, proceed in creating the Content Pack
Step 9. Verify the same for all nodes except CHILD nodeType.

As shown in FIG. 2A, a tree structure 216 associated with a new content pack X 220 can be created. A tree structure 218 has previously been created for an existing content pack Y 244. As shown in FIG. 2A, both the tree structures 216 and 218 include an agents node 222, a queries node 224, an alerts node 226, and an extracted fields node 228. For each of the trees 216 and 218, the agents node 222 includes three child nodes representing three agents: A1 230, A2 232, and A3 234; the queries node 224 includes two child nodes representing two queries: Q1 236 and Q2 238; the alerts node 226 includes one child node representing an alert AL1 240; and the extracted fields node 228 includes one child node representing an extracted field E1 242.

As is identical to the content pack YYY. Accordingly, the content pack xxx and the content pack YYY are duplicates. In some embodiments, the determination of duplicity causes the new content pack not to be loaded (e.g., to be discarded) and the existing content pack(s) to be retained. In some embodiments, the determination of duplicity causes a notification to be provided to a user. Such a notification can include, for example, a recommendation to the user to choose or reject one or more entities of a content pack. Because all these nodes are the same between the tree 216 and the tree 218, the content pack X 220 can be determined to be a duplicate of the content pack Y 244.

FIG. 2B is another diagram of tree structures associated with two content packs according to one or more embodiments of the present disclosure. As shown in FIG. 2B, the tree structure 216 associated with the new content pack X 220 has been created. A tree structure 218 has previously been created for a different existing content pack Z 245. As shown in FIG. 2B, both the tree structures 216 and 219 include an agents node 222, a queries node 224, an alerts node 226, and an extracted fields node 228. For each of the trees 216 and 218, the queries node 224 includes two child nodes representing two queries: Q1 236 and Q2 238; the alerts node 226 includes one child node representing an alert AL1 240; and the extracted fields node 228 includes one child node representing an extracted field E1 242. However, the agents node 222 of the tree structure 216 includes three child nodes representing three agents: A1 230, A2 232, and A3 234 while the agents node 222 of the tree structure 219 includes two child nodes representing two agents A1 230 and A2 232. That is, the tree structure 219 does not include the agent A3 234. Because at least one node is different between the tree 216 and the tree 219, the content pack X 220 can be determined not to be a duplicate of the content pack Z 245. Because it is not a duplicate, it can be loaded and/or saved.

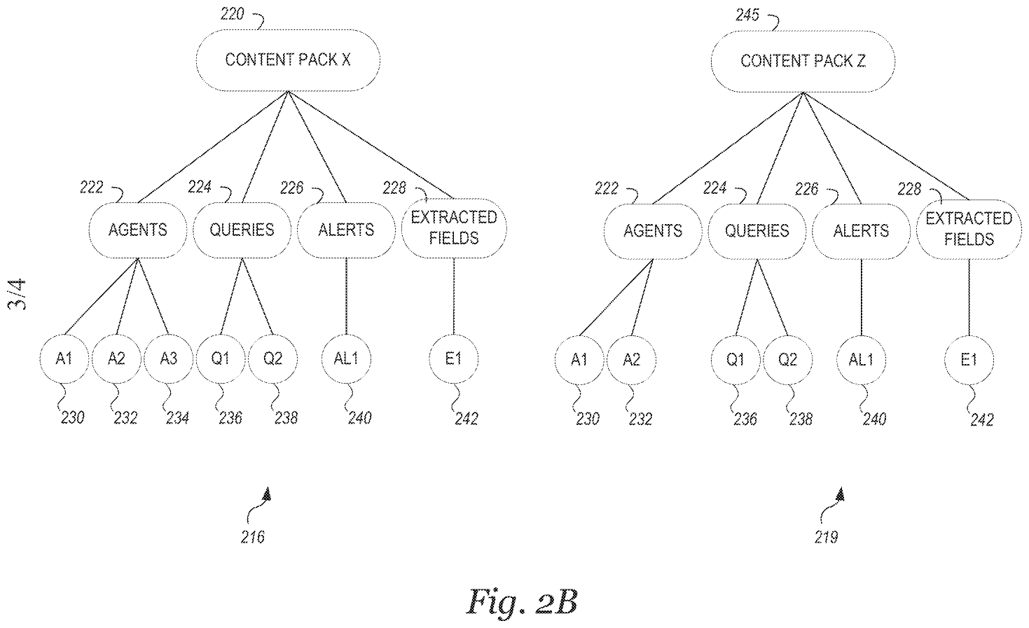

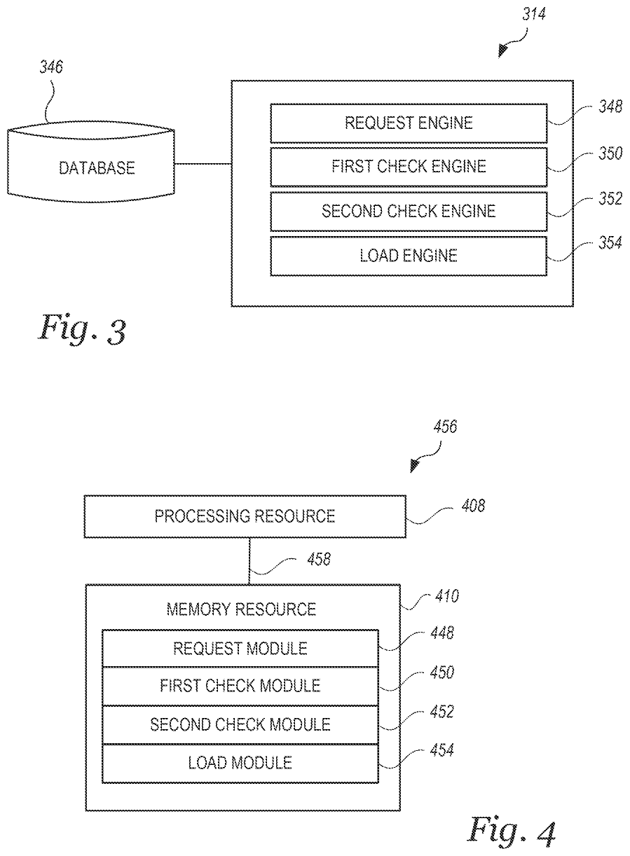

FIG. 3 is a diagram of a system 314 for determining duplicate entities in content packs according to one or more embodiments of the present disclosure. The system 314 can include a database 346 and/or a number of engines, for example request engine 348, first check engine 350, second check engine 352, load engine 354, and can be in communication with the database 346 via a communication link. The system 314 can include additional or fewer engines than illustrated to perform the various functions described herein. The system can represent program instructions and/or hardware of a machine (e.g., machine 456 as referenced in FIG. 4, etc.). As used herein, an “engine” can include program instructions and/or hardware, but at least includes hardware. Hardware is a physical component of a machine that enables it to perform a function. Examples of hardware can include a processing resource, a memory resource, a logic gate, an application specific integrated circuit, a field programmable gate array, etc.

The number of engines can include a combination of hardware and program instructions that is configured to perform a number of functions described herein. The program instructions (e.g., software, firmware, etc.) can be stored in a memory resource (e.g., machine-readable medium) as well as hard-wired program (e.g., logic). Hard-wired program instructions (e.g., logic) can be considered as both program instructions and hardware.

In some embodiments, the request engine 348 can include a combination of hardware and program instructions that is configured to receive a request to load a content pack. In some embodiments, the first check engine 350 can include a combination of hardware and program instructions that is configured to perform a first duplicity check between the content pack and a previously loaded content pack. In some embodiments, the second check engine 352 can include a combination of hardware and program instructions that is configured to perform a second duplicity check between the content pack and the previously loaded content pack responsive to a determination that the content pack passed the first duplicity check. In some embodiments, the load engine 354 can include a combination of hardware and program instructions that is configured to load the content pack responsive to a determination that the content pack passed the second duplicity check.

FIG. 4 is a diagram of a machine 456 for determining duplicate entities in content packs according to one or more embodiments of the present disclosure. The machine 456 can utilize software, hardware, firmware, and/or logic to perform a number of functions. The machine 456 can be a combination of hardware and program instructions configured to perform a number of functions (e.g., actions). The hardware, for example, can include a number of processing resources 408 and a number of memory resources 410, such as a machine-readable medium (MRM) or other memory resources 410. The memory resources 410 can be internal and/or external to the machine 456 (e.g., the machine 456 can include internal memory resources and have access to external memory resources). In some embodiments, the machine 456 can be a VCI. The program instructions (e.g., machine-readable instructions (MRI)) can include instructions stored on the MRM to implement a particular function (e.g., an action such as providing a notification, as described herein). The set of MRI can be executable by one or more of the processing resources 408. The memory resources 410 can be coupled to the machine 456 in a wired and/or wireless manner. For example, the memory resources 410 can be an internal memory, a portable memory, a portable disk, and/or a memory associated with another resource, e.g., enabling MRI to be transferred and/or executed across a network such as the Internet. As used herein, a “module” can include program instructions and/or hardware, but at least includes program instructions.

Memory resources 410 can be non-transitory and can include volatile and/or non-volatile memory. Volatile memory can include memory that depends upon power to store information, such as various types of dynamic random access memory (DRAM) among others. Non-volatile memory can include memory that does not depend upon power to store information. Examples of non-volatile memory can include solid state media such as flash memory, electrically erasable programmable read-only memory (EEPROM), phase change memory (PCM), 3D cross-point, ferroelectric transistor random access memory (FeTRAM), ferroelectric random access memory (FeRAM), magneto random access memory (MRAM), Spin Transfer Torque (STT)-MRAM, conductive bridging RAM (CBRAM), resistive random access memory (RRAM), oxide based RRAM (OxRAM), negative-or (NOR) flash memory, magnetic memory, optical memory, and/or a solid state drive (SSD), etc., as well as other types of machine-readable media.

The processing resources 408 can be coupled to the memory resources 410 via a communication path 458. The communication path 458 can be local or remote to the machine 456. Examples of a local communication path 458 can include an electronic bus internal to a machine, where the memory resources 410 are in communication with the processing resources 408 via the electronic bus. Examples of such electronic buses can include Industry Standard Architecture (ISA), Peripheral Component Interconnect (PCI), Advanced Technology Attachment (ATA), Small Computer System Interface (SCSI), Universal Serial Bus (USB), among other types of electronic buses and variants thereof. The communication path 458 can be such that the memory resources 410 are remote from the processing resources 408, such as in a network connection between the memory resources 410 and the processing resources 408. That is, the communication path 458 can be a network connection. Examples of such a network connection can include a local area network (LAN), wide area network (WAN), personal area network (PAN), and the Internet, among others.

As shown in FIG. 4, the MRI stored in the memory resources 410 can be segmented into a number of modules 448, 450, 452, 454 that when executed by the processing resources 408 can perform a number of functions. As used herein a module includes a set of instructions included to perform a particular task or action. The number of modules 448, 450, 452, 454 can be sub-modules of other modules. For example, the second check module 452 can be a sub-module of the first check module 450 and/or can be contained within a single module. Furthermore, the number of modules 448, 450, 452, 454 can comprise individual modules separate and distinct from one another. Examples are not limited to the specific modules 448, 450, 452, 454 illustrated in FIG. 4.

Each of the number of modules 448, 450, 452, 454 can include program instructions and/or a combination of hardware and program instructions that, when executed by a processing resource 408, can function as a corresponding engine as described with respect to FIG. 3. For example, the load module 454 can include program instructions and/or a combination of hardware and program instructions that, when executed by a processing resource 408, can function as the load engine 354, though embodiments of the present disclosure are not so limited.

The machine 456 can include a request module 448, which can include instructions to receive a request to load a content pack. The machine 456 can include a first check module 450, which can include instructions to perform a first duplicity check between the content pack and a previously loaded content pack. The machine 456 can include a second check module 452, which can include instructions to perform a second duplicity check between the content pack and the previously loaded content pack responsive to a determination that the content pack passed the first duplicity check. The machine 456 can include a load module 454, which can include instructions to load the content pack responsive to a determination that the content pack passed the second duplicity check.

Although specific embodiments have been described above, these embodiments are not intended to limit the scope of the present disclosure, even where only a single embodiment is described with respect to a particular feature. Examples of features provided in the disclosure are intended to be illustrative rather than restrictive unless stated otherwise. The above description is intended to cover such alternatives, modifications, and equivalents as would be apparent to a person skilled in the art having the benefit of this disclosure.

The scope of the present disclosure includes any feature or combination of features disclosed herein (either explicitly or implicitly), or any generalization thereof, whether or not it mitigates any or all of the problems addressed herein. Various advantages of the present disclosure have been described herein, but embodiments may provide some, all, or none of such advantages, or may provide other advantages.

In the foregoing Detailed Description, some features are grouped together in a single embodiment for the purpose of streamlining the disclosure. This method of disclosure is not to be interpreted as reflecting an intention that the disclosed embodiments of the present disclosure have to use more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

What is claimed is:

1. A non-transitory machine-readable medium having instructions stored thereon which, when executed by a processor, cause the processor to:
receive a request to load a content pack;
perform a first duplicity check between the content pack and a previously loaded content pack;
perform a second duplicity check between the content pack and the previously loaded content pack responsive to a determination that the content pack passed the first duplicity check; and
load the content pack responsive to a determination that the content pack passed the second duplicity check.

2. The medium of claim 1, including instructions to not load the content pack responsive to a determination that the content pack failed the first duplicity check.

3. The medium of claim 1, wherein the instructions to perform the first duplicity check include instructions to compare:
compare a name of the content pack with a name of the previously loaded content pack;
a version of the content pack with a version of the previously loaded content pack;
an author of the content pack with an author of the previously loaded content pack; and
a namespace of the content pack with a namespace of the previously loaded content pack.

4. The medium of claim 3, including instructions to determine that the content pack failed the first duplicity check responsive to a determination that:
the name of the content pack is identical to the name of the previously loaded content pack;
the version of the content pack is identical to the version of the previously loaded content pack;
the author of the content pack is identical to the author of the previously loaded content pack; or
the namespace of the content pack is identical to the namespace of the previously loaded content pack.

5. The medium of claim 3, including instructions to determine that the content pack failed the first duplicity check responsive to a determination that:
the name of the content pack is identical to the name of the previously loaded content pack;
the version of the content pack is identical to the version of the previously loaded content pack;
the author of the content pack is identical to the author of the previously loaded content pack; and
the namespace of the content pack is identical to the namespace of the previously loaded content pack.

6. The medium of claim 1, including instructions to create a tree structure associated with the content pack for the second duplicity check.

7. The medium of claim 1, including instructions to create a tree structure associated with the content pack, wherein the tree structure includes:
a first node corresponding to agents of the content pack;
a second node corresponding to queries of the content pack;
a third node corresponding to alerts of the content pack; and
a fourth node corresponding to extracted fields of the content pack.

8. The medium of claim 7, wherein the tree structure includes:
a child node of the first node corresponding to a particular agent of the content pack;
a child node of the second node corresponding to a particular query of the content pack;
a child node of the third node corresponding to a particular alert of the content pack; and
a child node of the fourth node corresponding to a particular extracted field of the content pack.

9. The medium of claim 1, wherein the instructions to perform the second duplicity check include instructions to:
create a first tree structure associated with the content pack;
create a second tree structure associated with the previously loaded content pack; and
compare the first tree structure with the second tree structure.

10. The medium of claim 9, including instructions to determine that the content pack passed the second duplicity check responsive to a determination that the first tree structure is different than the second tree structure.

11. A method, comprising:
receiving a request to load a content pack;
performing a first duplicity check between the content pack and a previously loaded content pack;
performing a second duplicity check between the content pack and the previously loaded content pack responsive to determining that the content pack passed the first duplicity check, wherein performing the second duplicity check includes:
creating a first tree structure associated with the content pack;
creating a second tree structure associated with the previously loaded content pack;
comparing the first tree structure with the second tree structure; and
loading the content pack responsive to determining that the first tree structure is different than the second tree structure.

12. The method of claim 11, wherein creating the first tree structure includes:
creating a first node corresponding to agents of the content pack;
creating a second node corresponding to queries of the content pack;
creating a third node corresponding to alerts of the content pack; and
creating a fourth node corresponding to extracted fields of the content pack.

13. The method of claim 12, wherein creating the second tree structure includes:
creating a fifth node corresponding to agents of the previously loaded content pack;
creating a sixth node corresponding to queries of the previously loaded content pack;
creating a seventh node corresponding to alerts of the previously loaded content pack; and
creating an eighth node corresponding to extracted fields of the previously loaded content pack.

14. The method of claim 13, wherein determining that the first tree structure is different than the second tree structure includes determining that:
a child node of the first node is different than a child node of the fifth node;
a child node of the second node is different than a child node of the sixth node;
a child node of the third node is different than a child node of the seventh node; or
a child node of the fourth node is different than a child node of the eighth node.

15. The method of claim 13, wherein determining that the first tree structure is different than the second tree structure includes determining that:
a quantity of child nodes of the first node is different than a quantity of child nodes of the fifth node;
a quantity of child nodes of the second node is different than a quantity of child nodes of the sixth node;
a quantity of child nodes of the third node is different than a quantity of child nodes of the seventh node; or
a quantity of child nodes of the fourth node is different than a quantity of child nodes of the eighth node.

16. A system, comprising:
a request engine configured to receive a request to load a content pack;
a first check engine configured to perform a first duplicity check between the content pack and a previously loaded content pack;
a second check engine configured to perform a second duplicity check between the content pack and the previously loaded content pack responsive to a determination that the content pack passed the first duplicity check; and
a load engine configured to load the content pack responsive to a determination that the content pack passed the second duplicity check.

17. The system of claim 16, wherein the content pack is a newly created content pack.

18. The system of claim 16, wherein the content pack is a customized content pack.

19. The system of claim 16, wherein the content pack is associated with a migration from a first log analytics solution to a second log analytics solution.

20. The system of claim 16, including a recommendation engine configured to provide a recommendation responsive to a determination that the content pack failed the second duplicity check.
